(19) United States
(12) Patent Application Publication
(10) Pub. No.: US 2010/0239190 A1
(43) Pub. Date: Sep. 23, 2010

(54) Tamper-Evident System and Methods For Storing Property

(76) Inventors: Ambrose J. McNamara, Los Angeles, CA (US); Kenneth Makowka, Wilton, CT (US)

Correspondence Address: Valauskas & Pine LLC, 150 South Wacker Drive, Suite 620, Chicago, IL, 60606, US

(21) Appl. No.: 12/729,908

(22) Filed: Mar. 23, 2010

Related U.S. Application Data
(60) Provisional application No. 61/210,802, filed on Mar. 23, 2009.

(51) Int. Cl. B65D 33/16; B31B 41/14; B31B 1/74

(52) U.S. Cl. 383/5; 493/227; 493/210

(57) ABSTRACT

A tamper-evident system and method is disclosed to be used to provide evidence that the contents in a container have or have not been tampered with prior to the intended opening of the container. The tamper-evident system and method also acts as a deterrent to those attempting unauthorized access the contents of the container. The system and method of the present invention can be practiced or used in conjunction with bulky items such as winter coats and boots, sleeping bags and with containers, such as suitcases, backpacks, bags, briefcases, either singularly or in total with cubic capacity that is greater than that available in two-dimensional tamper-evident containers, particularly those with distinct hard corners to be used by, for example, a patient at a hospital or medical facility, or computers and the like that are being removed for evidentiary purposes.

### PRIORITY STATEMENT

This application claims the benefit of U.S. Provisional Application No. 61/210,802, filed Mar. 23, 2009.

### FIELD OF THE INVENTION

The present invention relates to a tamper-evident system and method to be used to provide evidence that the contents in a container have or have not been tampered with prior to the intended opening of the container. The tamper-evident system and method also acts as a deterrent to those attempting unauthorized access the contents of the container. The system and method of the present invention can be practiced or used in conjunction with bulky items, such as winter coats and boots, sleeping bags and with packages, such as suitcases, backpacks, bags, briefcases, particularly those with distinct hard corners, where an item or package has a singular or total demand for cubic capacity to be used by, for example, a patient at a hospital or medical facility, or computers and the like that are being removed for evidentiary purposes.

More particularly, the present invention relates to tamper-evident and tamper-deterrent systems and methods that can be used to keep a record of the contents as necessary, the travel history of the container itself, safeguard the contents or act as a deterrent to unauthorized access to the contents, provide evidence of any unauthorized access to the contents enclosed in the container, and/or provide evidence of tampering and all the protections that evidence provides.

### BACKGROUND OF THE INVENTION

Tamper-evident is a term used to describe a container with a secure closure detection method, which can detect any attempt to open through various means such as physical destruction, using heat or cold. Tamper-evident can also be included in a container design, such as heat sealed sides, etc. Tamper-evident is not the same as tamper-proof. With enough time and money, any container system can be defeated, such as by purchasing counterfeit copies of the containers with all of the possible numbers so that a switch would not be noticed, along with, forged numbered receipt forms to make counterfeit deposit slips, etc. The issue is whether a thief would go through all of the time and expense for the container.

Tamper-evident closure systems have been around for a long time. For example, these systems can be as rudimentary as a locked suitcase in which unauthorized access is evident based on a broken lock or a cut in the side of the suitcase. Either way, when the suitcase is returned to the owner, it is obvious that someone made an unauthorized attempt to access the contents of the suitcase. At that time, the owner can begin to question the party or parties that had possession of the suitcase during travel.

Tamper-evident systems have become more complex as attempts have been made to hide the theft or the altering of the contents. As an example of a need for a tamper-evident system, a company intends to deposit $1,000 from its daily cash receipts into its bank account. An employee puts $1000 into a bag and drops it into the night deposit box with a note saying Account #1234. Next day the bank teller opens the bag and finds only $900. The employee claims that $1000 was placed in the bag, but there is no indication if the employee, the bank teller or someone else took the money.

Instead, the employee fills out a standard bank deposit slip for $1000 and puts the money and the slip into a standard bank deposit bag that has a standard adhesive tamper-evident closure. When the bank teller opens the bag and finds only $900 and a deposit slip for $900, there may be no sign of being opened, however there is a missing $100 and a deposit slip for $900, not $1000. The thief may have opened the tamper-evident bag, took out $100, used a new standard bank bag and filled out a new deposit slip for $900. The thief discards the first tamper-evident bag and first receipt. The tamper-evident bag allowed for “switching” contents, minus any unauthorized removals, to another bag to make it look like there was no tampering.

Next, the company uses a tamper-evident bag with a removable numbered receipt system and puts $1000 in the bag. The employee also puts in one copy of a completed deposit slip showing $1000 and keeps a copy for its records. Thus the company has the bag number and a copy of the amount deposited.

Now thief has two hurdles; how to switch to a new bag when the customer has a receipt of the original bag number, and how to switch to a new deposit slip when customer has a copy of the original deposit slip and original amount. However, if the thief uses a metal straight edge ruler and razor to cut a thin line along one side of the bag, he can reach in with a long tweezers and remove the $100. The thief can then use a cigarette lighter to heat up a wire coat hanger to reseal the slit in the side of the bag hiding any evidence of tampering. When the bank teller opens the bag, which appears untouched, he finds $900 and a deposit slip for $1000. On careful inspection, bank finds side slit that was resealed. The bank does not know who or when the theft happened but it now sees that there is theft either at the beginning, in the middle of, or at the end of the route this bag took.

Next, the company begins to use a numbered bank deposit bag with wide side seals and follows the same procedures above but with a more advanced system. Now, the thief uses the hot air from a hair dryer to soften the adhesive holding the bag mouth closed. He uses tweezers to get the $100, and again the bank can see no signs of entry, however the $100 is still missing. The company begins to use a heat sensing glue, such as that disclosed in Makowka (see below), in which blue dots form near the bag mouth where there originally were clear circles. Now there is an indication of the attempt to open the bag using heat. The bank then has additional evidence to find the culprit, and can begin looking for a situation where a hair dryer or another heat source could be used.

The history of the container or enclosure is also relevant. Bags, or sacks, started out as simple open mouth devices made from cloth fabric or animal hides that were sewn into a shape. Bags evolved into common everyday ubiquitous products. Bags can be made from paper, plastic film, foil, or other materials. Many bags are made on high-speed machines by heat sealing along the seams. However, bags can also be made through stitching the seams or closed using an adhesive.

Bags can be divided into several broad categories, such as three-dimensional bags or as two-dimensional bags. Three-dimensional bags often have an open mouth and are commonly called gusseted bags. These bags are made from extruded plastic film tubes that are cut into shapes and then heat sealed and/or glued into shapes that have width, length, and depth. The third dimension is a side gusset, which is a fold on both sides of the bag. When opened, the gusset creates a third dimension so that a 10×10 bag can become a 10×10×3 bag. Some gusseted bags have straight sides without a gusset, but have a gusset on the bottom to give the bag more material to expand at the bottom end to accommodate more contents than a simple flat bag.

Shopping bags are three-dimensional bags often supplied with either cut out or attached carrying handles. Plastic film bags commonly used for storing belongings are either two-dimensional or gusseted three-dimensional with either drawstring closures or plastic handles that snap together. Three-dimensional bags take up less space in storage and shipping and provide greater capacity to hold items.

Another type of bag known in the art is a two-dimensional flat open mouth bag. This type of bag can often hold two-dimensional items with length and width varying greatly from 1×1 inch to 40×40 inches and larger plus a third dimension that can range from the thickness of a single sheet of paper to a very large dimension. The manufacturing process uses the flat form material, folding, cutting, and sometimes gluing or heat pressuring edges to form the sides and bottom of the bag. The mouth of the bag is left open while the sides and bottoms are closed through adhesive, heat, pressure, or another method.

Alternatively, the bag mouth can be closed with simple folding or bunching of the neck area. To secure the closure, sometimes a closing mechanism, such as stapling, applying adhesive tape, a clasp, a zipper, a zip lock, or a spring clip was added to close the bag. Bags can also be closed by, for example, tying the bunched neck around and into itself, wrapping a twist tie around the neck, tying string around the neck, or wrapping a cable tie around the neck.

In cloth bags, a metal or plastic zipper can be sewn in or a series of buttons and buttonholes can be used to secure the closure. In other cloth bags, such as Army duffle bags, metal grommets in the periphery of the bag mouth can be slid one-by-one over a metal turnbuckle or loop. Then a simple spring clip could be inserted to hold all the grommets in place. Also, a padlock could be inserted into the turnbuckle above the grommets to create a more secure closure.

Modern plastic film bags were developed to be opened and closed over and over again with the commonly called zip lock closure where “male” and “female” parts of the zipper mechanism are applied to the flat film before it is folded and sealed into a bag. Slider zip locks are an advance on the system allowing easier grip in closing and opening. It is not feasible to add zip lock closures to three-dimensional bags due to the difficulties in the basic manufacturing process of such bags.

Nevertheless, all of these methods for closure lack a functionality allowing a person to detect whether the bag has been opened or tampered with during the time since the user last closed the bag. A closure mechanism such as a tying string around the neck of the bag could slip off or could be easily re-secured without detection.

As described herein, there is a need for tamper-evident systems and methods and insofar as related thereto, tamper-evident bags. For example, law enforcement agencies including police officers, sheriffs, security officers, federal agents, and state and federal agencies require a method to store evidence such that they can preserve the evidence and ensure the integrity of the evidence by showing a secure chain of custody:

Some bags with closures allowing detection of tampering have been developed. One known tamper-evident flat bag uses an adhesive strip covered by a silicone release paper. When a user pulls off the paper, the adhesive is exposed to the opposite side of the bag mouth area. The user presses down along the adhesive, thereby sealing the bag. If anyone pulls on the sealed mouth hard enough to separate the sides, the word “VOID” or “OPENED” appears. The opening of the bag activates the ink, which cannot be erased.

Tamper-detection qualities can be added to a two-dimensional bag by heat sealing the sides and the bottom. Most important, the top opening or mouth of the bag is comprised of a tamper-evident sealing system. Before the film is folded into a bag shape, an adhesive-strip, straight edged-tape covered by release paper tape is applied, while the contact section of the sealing area is denoted (quite often in red ink) and/or chemically treated to improve the adhesion qualities.

As also described herein, those wishing to access the contents of a bag, without alerting others, could open a tamper-evident sealed bag, remove or alter the contents, and then load the remaining or altered material into a new bag of the same design and size, throwing away the original bag.

Other known methods of tamper detection include strap style and pad lock style security seals that have printed numbers, such as American Casting and Manufacturing parts 360 and 1001L. While these security seals could hold the crumbled up bag neck closed, they could be removed and replaced with a new security seal with a different number.

Since the security tie or seal was wrapped around the exterior next of the bag it can be removed from the bag by sliding it up and off the surface. Since there was no number on the bag or in the bag or stored separately from the bag, this switching of the seals would go unnoticed and thus the closure was not tamper-evident.

Tamper-evident technology on two-dimensional bags was greatly improved by Makowka (e.g., U.S. Pat. No. 5,405,197; 5,391,136; 5,077,001; 4,834,552 and 4,733,817), whereby a temperature sensitive sealing adhesive would react to thermal attacks on the sealing area, creating an indelible mark or marks that were previously transparent. Additionally, Makowka invented a jagged-edge sealing tape to replace the straight edges tape. Attempts to pry or chisel the tape would break off the small tooth edges providing visual evidence of tampering.

These technologies do not address the problem of a person opening a two-dimensional bag and using a brand new bag. Further, these developments do not solve the problem of storing property that has a total cubic capacity that is greater than available in tamper-evident two-dimensional bags. Also, a two-dimensional bag can be increased in size—within limits of approximately 26 inches by 30 inches to hold angular property, but the edges of the angular property, such as the corners of a box, will often cause a tear in the bag. When the angular property is large in size, the likelihood of tearing the bag increases.

A variety of professionals including, for example, firefighters, field scientists, and hospital workers need tamper-evident three-dimensional bags. Firefighters who encounter heavy oily smoke from fires that contaminate their special turn out gear or who contact body fluids from injured or deceased persons that create a different type of contamination, must have the turn out gear laundered according to established specifications (NFPA and similar standards in USA and other countries).

Turn out gear is assigned to specific individuals as they are fitted by size. The turn out gear comes in two different configurations: A four-piece set and a 2-piece set. Each piece has a sewn in label with a serial number for that item of gear. Sometimes the serial number is recorded in a database at the fire department, connecting the numbers to a specific fire fighter by name. Sometimes the serial number is recorded in a database at a cleaning laundry, connecting the item either to a name but more likely just to the fire department that sent in the gear for cleaning.

Turn out gear is sometimes laundered for general cleaning in the fire stations own washer and extractor dryer. But as required by standard the contamination of oils or body fluids requires advanced cleaning by a professional cleaner with specialized equipment. The turn out gear is sent to or picked up by the cleaning contractor. The two upper parts and two lower parts of the gear are detached from each other and cleaned is separate batches.

After cleaning, the gear is returned to the fire department that sent it in. Quantities can range from just 2 or 3 sets from one specific fire department to hundreds of sets from a mixture of fire departments. A great deal of time is consumed determining which specific piece of turn out gear goes back to what specific fire fighter.

While the outer jacket shell might have the fire fighter's name on it, the other remaining parts do not unless they were hand written into the inner flaps of pockets or similar areas that are not rubbed on. Even when written in, the name is often illegible to begin with and often wears away after washing. Accordingly, fire departments need a tamper-evident bag with an associated form that correlates identifying information of the gear with a specific firefighter.

Another group of personnel needing tamper evident bangs include agricultural field scientists who collect samples of, for example, dead squirrels and mice to check for the presence of the Hanta virus. The carcasses are placed into plastic bags and usually tied or taped shut and sent to the laboratory for testing. However, there is no clear chain of custody of these carcasses if the containers are not tamper-evident.

The typical hospital advises patients coming for elective medical procedures to leave their valuables at home or, if they forget, to have the accompanying spouse or friends take these items home. In other situations where the items cannot be returned home or placed elsewhere, such as motor vehicle accident victims, cardiac arrest patients, etc.; all admissions to the Emergency Department, the two-dimensional property bags were used satisfactorily.

However, an unusual aspect of a Veteran Affairs Medical Center or VAMC facility is the arrival of a homeless veteran, who by definition has no place at which to leave his property. The homeless veteran would arrive at the VAMC with everything he owns in suitcases, backpacks, bags, cases, etc. The two-dimensional bag did not provide the necessary size and evidence of tampering used on smaller items.

Two-dimensional bags fail to adequately provide the necessary-cubic capacity and evidence of tampering that a three-dimensional bag can provide. Accordingly, besides the need for a tamper-evident system and method that overcomes the prior art shortcomings, there is a need for a tamper-evident container or bag that precludes and prevents a person from switching out the bag.

Currently, the prior art is void of tamper-evident systems and methods that solve the problems and disadvantages set forth herein. Further, there are no machine-made tamper-evident three-dimensional plastic bags primarily based on the enclosed tube form of manufacturing. Thus, there is a need for the tamper-evident system and methods disclosed herein.

### SUMMARY OF THE INVENTION

A tamper-evident system provides benefits in two ways. It provides proof that anyone handling the container did not access the contents to remove or alter the contents, after the container was sealed closed; and it provides a deterrent to those contemplating a theft of the contents. A tamper-evident system functions as an alert system to show anyone along the path of travel of the container that someone prior to them may have tampered with the container. It may also act as a visual alarm when the bag is opened or reclaimed and there is a clear discrepancy between the bag number and/or the related paperwork or other number connecting data and the original data.

As such, tamper-evident methods and systems are beneficial in situations where the chain of custody is important. If the third person in the chain of custody signs for the bag and fourth person sees signs of tampering when the bag arrives, the search can revert backwards to find the culprit.

For purposes of the present invention, tamper-evident system and methods are discussed in reference to many examples, including a container or bag system used to store the property of a patient in a medical care facility. These examples are merely exemplary and it is contemplated that the system and methods described herein could be used in any situation where a container may be needed to enclose property, detect and deter unauthorized tampering, and prevent the replacement of the container without detection.

For purposes of this application, property includes items owned by the user including, inter alia, a purse, backpack, trash bag stuffed with clothes, computer and computer related items, suitcases, tool boxes, musical instrument cases, clothes, books, food, evidence in a civil or criminal investigation, and any other item that can be placed into a container. Property can further include items not expressly owned by the user including, inter alia, items owned by the employer of the user, samples taken from nature, or items owned by a relative or friend.

The present invention is a system and method for securing the property of a user when the property is stored away from their observation and providing evidence of tampering with the property, either to remove the property from its container or to alter the property that remains in the container. The system and method makes tampering obvious, and thus acts as a deterrent to such tampering. For example, evidence of tampering acts as a deterrent and reduces the chance that another will tamper with a person's property while it is stored away from them. In addition, the container or bag system provides the necessary identification of the owner simplifying reclaiming one's property.

The tamper-evident system and method may include a bag, a secure closure element, and a disturbance detection system. In the preferred embodiment, the bag is made from plastic material, but it is also contemplated that the material is paper, cloth, or another suitable material. A preferred embodiment of the bag has three dimensions, such that the bottom has a flat surface, and three or more side surfaces. The bag also includes a closure element receiving apperatures.

One embodiment of closure element receiving aperatures are holes in the bag. These holes are the size and shape of a standardized hole punch, but it is also contemplated that the holes be other sizes and shapes including, inter alia, a square slit or an irregularly-shaped gap.

The secure closure element must be a closure mechanism that cannot be unlocked without destroying the element itself. The secure closure element can be a tie having head and a tail, where when the tail folds into a slot on the head, the tail cannot be released from the slot. The tail could accomplish this by having jagged edges that get caught on the edges of the slot when trying to remove the tail.

Further, the tamper-evident system includes an disturbance detection system or identification system, such as a numbering or tracking system that connects the specific original container to a numerical reference and/or printed receipt that can be removed from the container, plus paperwork or the like in which the original data is in copy form and located separate from the container or bag and its path of travel.

The secure closure element holds a piece of the disturbance detection system together with the bag. The disturbance detection system may include a multipart form, which may be made up of several forms with matching identification marks, such as numbers, letters and/or symbols. Each part of the form is stored in a different location. For example, one part of the form is fastened to the bag through the secure closure element. Other parts of the form could be stored, inter alia, inside of the bag, with the property owner, in an administrative office of the entity holding the bag, or with a file for the property owner.

It is contemplated that each part of the form is a piece of paper with a variety of information included on it. The form that is fastened to the bag through the secure closure element such as a tie need only have the identification symbols on it, but may include information including the property owner's name, address, phone number, employee number, doctor's name, hospital room number, or other information.

There are a number of-ways to create a connection between the number on the security tie and a separate item, including printing the same number on the bag or container, such that a switched security tie will not match the number on the bag; printing the number on a multi-part form and placing copies of the form in different places such as inside the bag, outside the bag, a copy in the office files, etc.; writing the security tie number in a log file; putting the original tie number in a data collector; and taking a picture of the original tie number in place as it holds the bag closed, among others.

In use, the preferred embodiment of the tamper-evident system allows for a qualified person to carefully check the bag or container contents and place that checked bag into a three-dimensional clear plastic bag with punched holes. Before closing the three-dimensional bag using a security tie, the inspector completes a form, such as a two or three part NCR form, with the proper information, such as name, date, etc., as well as when the bag should be next inspected. One copy of the form is placed inside the clear bag where the information can easily be seen, especially when the next inspection will occur. A second copy of the form is kept separate in the office. The two forms have the same number as the number on the security tie.

The daily inspection of the container now only needs to confirm that the bag has not been opened and the numbers match. If the contents of the bag are needed, the bag can be opened, the numbers checked, and a qualified person can perform a new inspection as necessary, using a new container, form, etc.

In an alternative embodiment, a flat bag or mare likely a three-dimensional bag can be securely closed by one numbered tamper-evident security tie. That bag may contain a body, for example the body of a person found during a criminal investigation. A separate tamper-evident security tie with the same number is used to close another bag, for example, a property bag with the decedent's property items. A third tamper-evident security tie with the same number can be attached directly to the decedent's body. That same number on all the security ties can be recorded in a data log or in a photograph. With this system, the disadvantages of identity errors for the body and personal property are reduced or eliminated.

Further, one or more of the security ties can incorporate RFID technology to have the identity number accessible through that RFID technology to help locate a specific bag with either the number, or a description of a specific person, especially in situations where a large number of bags of items were being accessed.

One embodiment of the present invention includes a three-dimensional bag for storing property. This prevents the sharp edges of an angular property item from tearing the bag because it provides a bottom surface on which the angular edges can sit without tearing the side surfaces. Angular property includes, inter alia, suitcases, tool boxes, and musical instrument cases. Where a flat two-dimensional bag measuring a size, for example, 19 inches by 20 inches will lose linear (two-dimensional) capacity as the bag is pulled in and up by the bulky item. For example, a box 12 inches wide by 18 inches long by 10 inches high will not fit into the bag cavity and the sealing system can not be engaged.

Another embodiment of the present invention is a three-dimensional tamper-evident bag system that is primarily based on a tube manufacturing method. Another embodiment of the present invention is a three-dimensional bag having a frame to support the bag.

Another embodiment of the present invention includes a pouch on the surface of the bag. The pouch can be a storage location for one of the parts of the multipart form. In one such embodiment, the pouch is sealed with the form in it before a user leaves the bag. The pouch adds an added level of security such that the will be able to detect tampering if the pouch form does not match the form in the user's possession.

The detailed description of the invention below is intended to be illustrative only and not intended to limit the scope of the invention. It should be understood that the invention may be practiced otherwise than that specifically described herein and still be within the scope of the claims, and that changes and modifications are possible with respect to the foregoing description.

### BRIEF DESCRIPTION OF THE DRAWINGS

FIG. 1 illustrates a front view of a tamper-evident container or bag in accordance with the present invention;

FIG. 2 illustrates a front view of a tamper-evident container or bag in accordance with the present invention;

FIG. 3 illustrates a secure closure element in accordance with the present invention;

FIG. 4 illustrates a multipart form in accordance with the present invention;

FIG. 5 illustrates a front view of a tamper-evident container or bag in accordance with an alternative embodiment of the present invention; and

FIG. 6 illustrates a front view of a tamper-evident container or bag in accordance with an alternative embodiment of the present invention.

### DETAILED DESCRIPTION OF THE PREFERRED EMBODIMENTS

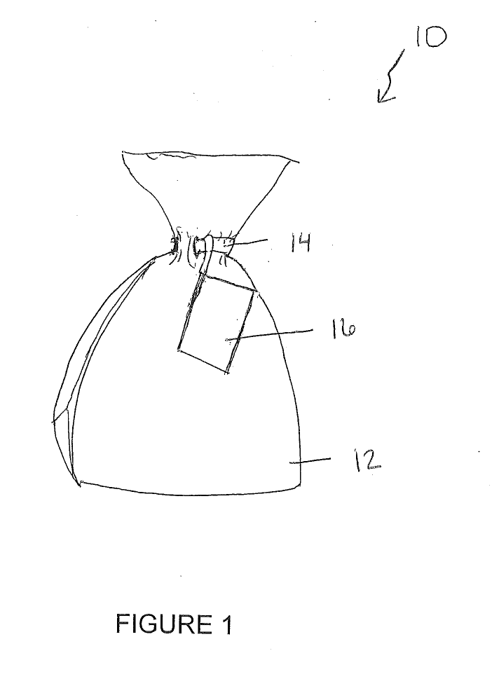

FIG. 1 shows a container 10 to be used in connection with the present invention, a tamper-evident system and methods. The container 10 illustrated in FIG. 1 is for exemplary purposes only and is not intended to limit the scope of the inventive tamper-evident system and methods.

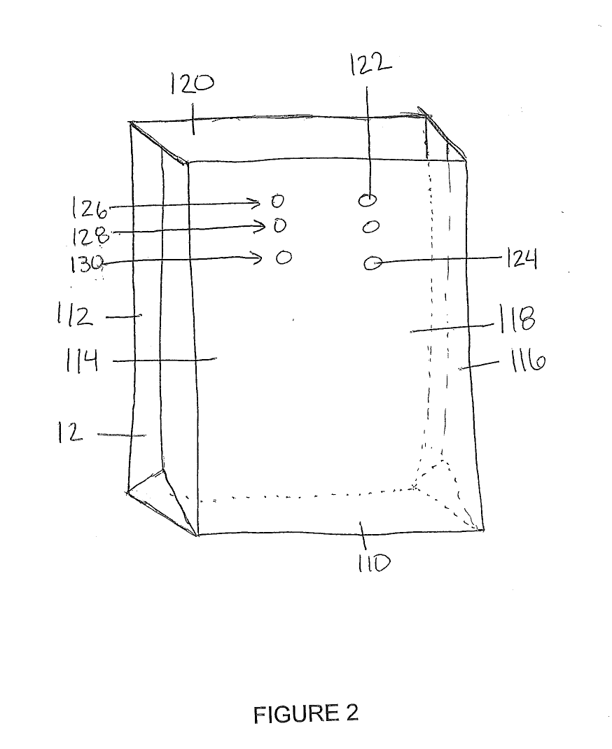

The container includes a bag 12, a secure closure element 14, and disturbance detection system 16. A preferred embodiment of the bag has three dimensions, such that the invention includes a bottom surface, and three or more side surfaces. FIG. 2 shows an embodiment having a bottom surface 110, a first side surface 112, a second side surface 114, a third side surface 116, and a fourth side surface 118. The embodiment of FIG. 2 has an open top 120 with no lid or cover.

The bag 12 also includes closure element receiving apertures 122. One embodiment of closure element receiving aperatures 122 are holes in the bag 124. The embodiment of FIG. 2 shows a first row 126, a second row 128, and a third row 130 of holes. The three hole rows allow the user to size the bag at the right height to securely enclose the property stored inside.

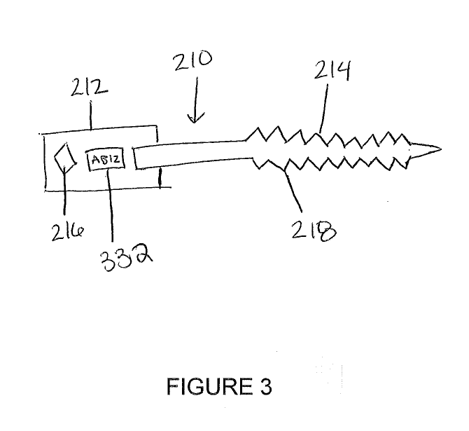

A secure closure element 14 must be a closure mechanism that cannot be unlocked without destroying the element itself. The embodiment of FIG. 3 shows a secure closure element 14 as a tie 210 having head 212 and a tail 214, where when the tail 214 folds into a slot 216 on the head 212, the tail 214 cannot be released from the slot 216. The tail 214 could accomplish this by having jagged edges 218 that get caught on the edges of the slot 216 when trying to remove the tail 214 from the slot 216.

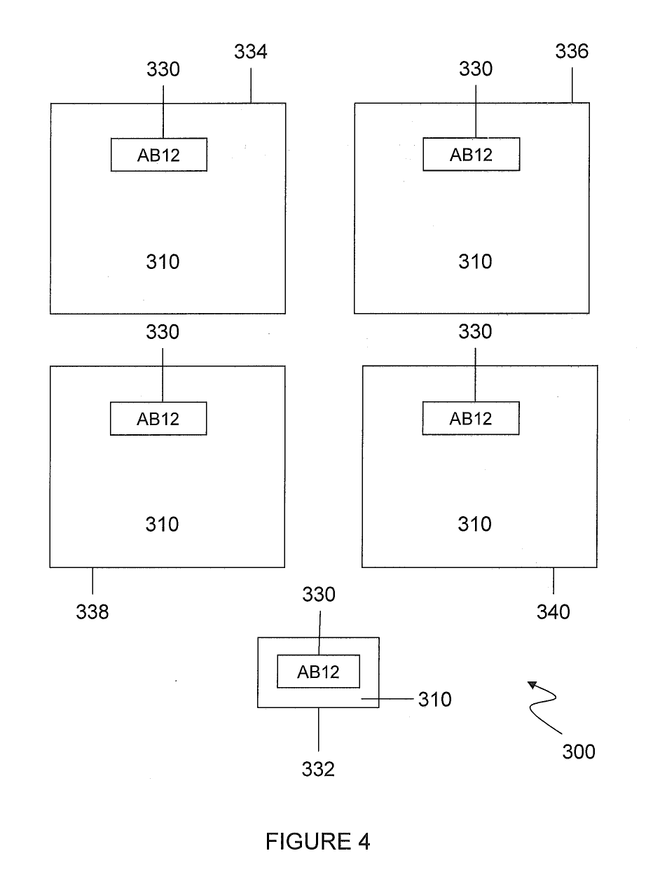

The secure closure element 14 holds a part of the disturbance detection system 300 together with the bag 12. The disturbance detection system 300 includes a multipart form 310. The multipart form 310, shown in FIG. 4, includes several forms with matching identification symbols 330, in this case the alphanumeric indication AB12. The identification symbols 330 include, for example, alpha-numeric characters, punctuation marks, or greek characters, although any type of identification mark can be used.

Each part of the multipart form 310 is intended to be stored in a different location, and the present invention is not limited to a four-part form as more or less parts may be necessary depending on the situation. As an example, a first part 332 of the form is fastened to the bag 100 through the secure closure element 210. A second part 334 of the form 310 could be stored inside of the bag or container 12, a third part 336 of the form 310 could be handed to the property owner; a fourth part 338 of the form 310 can be placed in an administrative office of the entity holding the bag 12; and a fifth part 340 of the form 310 can be placed in a file pertaining to the property owner.

It is contemplated that each part of the form includes a selection of information on it. The form that is fastened to the bag through the secure closure element 210 need only have the identification symbols 330 on it, but it may (along with the other forms) include information about the property owner, such as name, address, phone number, employee number, doctor's name, hospital room number, or other information. The information can also pertain to the contents of the container 12 for evidentiary reasons.

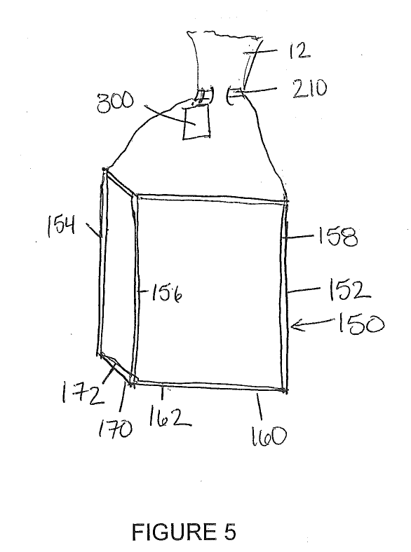

An alternative embodiment of the present invention includes a frame 150 located or incorporated into the bag 12 to protect the bag from tearing while storing angular property or property with sharp edges. This prevents the sharp edges of an angular property item from tearing the bag 12 because it provides a bottom surface on which the angular edges can sit without tearing the side surfaces. Angular property includes, inter alia, suitcases, tool boxes, and musical instrument cases. As shown in FIG. 5, the frame 150 includes vertical bars 152, horizontal bars 160, and depth bars 170. The vertical bars 152 of FIG. 5 include a first vertical bar 154, a second vertical bar 156, a third vertical bar 158, and a fourth vertical bar (not shown). The horizontal bars 160 of FIG. 5 include a first horizontal bar 162 and a second horizontal bar (not shown). The depth bars 170 include a first depth bar 172 and a second depth bar (not shown).

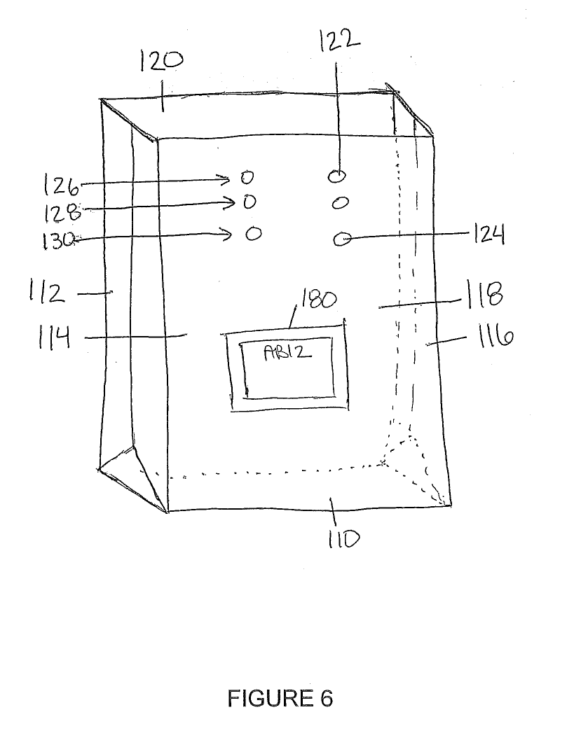

Another embodiment of the present invention includes a pouch 180 on the outside of the bag 12. The pouch 180 can be a storage location for one of the parts of the multipart form 310. In one such embodiment shown in FIG. 6, the pouch is sealed with the form in it before a user leaves the bag. The pouch adds an added level of security that will allow the detection of tampering if the pouch form does not match the form in the user's possession.

Accordingly, the present invention is a tamper-evident system and methods that can utilize a container or bag 12, which is also capable of enclosing large size items, such as suitcases, backpacks, tool boxes, musical instrument cases, plastic trash bags stuffed with clothes, bodies, etc. and provide the necessary identification and evidence of any tampering with the contents of the container. One purpose of such a tamper-evident system is to visually show whether a container or bag 12 used in the present invention was tampered with or disturbed.

Although many different sized bags may suffice for enclosing a container and providing evidence of tampering, the preferred embodiment of the bag of the present invention is a clear plastic side gusseted bag measuring 30×24 inches wide (52″ Lay Flat) by×66 inches deep, with holes 122 punched at selected points as shown in FIGS. 2 and 6. The purpose of the holes 122 is to secure the closure mechanism in place such that the closure mechanism 210 could not slip off of the bag.

Although the preferred embodiment contemplates plastic, the bag can be paper or any other pliable material. The bag shape can be flat, side gusseted or bottom gusseted. In the preferred embodiment, ¼ inch diameter holes are located 3 to 4 inches in front each side and down 6 inches, 18 inches, and 30 inches respectively, with hole through all 4-layers of film and in parallel alignment with the holes on the opposite side of the clear bag. A closure mechanism 210 as shown in FIG. 3, such as a string or cable tie can be threaded through two or more of these holes 122 to secure the closure. Of course, various sizes, number of holes 122 and hole locations can be incorporated without exceeding the scope of the present invention. These holes 122 can be punched when the bag is manufactured or added afterwards to create a custom sized security capacity.

By printing an identification symbol 330 on the bag 12 and also on some tear-away portion of the bag 12, the switching of bags 12, whereby someone opens the securely closed bag 12, removes or alters the contents and places the altered contents in a new bag 12 of the same make and model, but with a different serial number. While the bag looks like it has never been tampered with—and that is true—it is a substitute bag for the original bag and this substitution or switching will be evident when the bag owner uses his/her receipt to reclaim the original bag 12.

Another component of the present invention is a flat-film tamper-evident bag whose purpose is to hold a copy from the multiple-part form 300. This copy is referred to as the Reclaim Receipt and can be placed into the bag 12 at the time it is sealed. The bag has an identification or ID number that matches the number on the security tie 210 and the 4-part form 300. The bag 12 has checklists and prepared areas to clearly identify the owner of the contents of the bag 12, the staff who loaded and sealed it, dates, etc. The number of the bag 12 should be entered into a computer record for the patient or into a logbook.

When it is time to reclaim the contents of the bag 12, the patient (or other person) will first obtain and sign the Receipt Bag. Opening the Receipt Bag, the person can then use the Reclaim Receipt to retrieve the bag. The person signs the Reclaim Receipt acknowledging receipt of the still sealed and not pierced or cut bag containing the patient's property. The completed Reclaim Receipt stays with the institution.

The tamper-evident system and method of the present invention includes completing the form and using the different parts of the form to keep track of the contents and any information related thereto, and to provide evidence if switching of the container has taken place. In the case of a suitcase or backpack for the VAMC, after filling in the blanks, the form can be divided as follows:
one copy goes inside the bag before it is closed and sealed
one copy is attached to the outside of the bag surface via an adhesive backing
one copy is for the Property Dept or optionally can be given to the patient or representative as documentation of receiving and bagging the item
the fourth copy—and only this copy—is to be used to reclaim the item in the sealed bag and document that this property was returned (or some other action as noted herein). This fourth copy is to be placed into a special version of a flat, two-dimensional tamper-evident bag.

Additionally, the serial number can be recorded in the patient's records for future reference. An attempt to switch the security seal would require substituting the seal itself which would have a new number and to switch the parts of the NCR form that are inside the bag and on the outside of the bag. However, the part of the NCR form that the owner uses to reclaim his bag will not match the switched NCR form and switched numbers.

After completing the 4-part NCR form 300 and locating the copies as described above, the small end of the security tie or seal 210 is threaded through the holes 122 punched through the large clear bag 12, all holes 122 on the same level. Then, as shown in FIG. 5, the small end of the security tie 210 is threaded through the hole 122 in the flag end of the security seal and pulled through to cinch up the security tie 210 as tightly as possible. The top of the bag 12 above the security tie 210 is bunched up as shown. FIG. 5 shows a suitcase inside a sealed tamper-evident bag 12 in accordance with the present invention, with one copy of the 4-part form 300 adhered to its outer surface (shown in FIG. 6).

To access the contents of the tamper-evident bag 12, a person must do one or more of the following:
cut the bag surface and then repair the cut with tape;
break the security tie to open the top of the bag; or
undo the machine heat sealed bottom of the bag and reseal it by hand.

All of these actions leave visible marks that indicate tampering. If someone working inside the organization charged with caring for the sealed bag were to try to access the bag contents via a “switch” it would be as follows:
break the security seal;
access the contents as desired;
use a new bag with new security tie with number matching; and new 4-part NCR form; filling in all the data points.

However, one copy of the original receipt (the reclaim receipt) has been kept separately away from the bag and therefore, the number of the switched security tie and 4-part form will not match.

The special PVS bag 12 has the exact same number, i.e. AB12, as the security tie 210 and 4-part printed NCR form 300. The bag 12 has places to record the key information on the owner of the property and who sealed the bag, among other information. This PVS912 bag, with the 4^{th} copy of the receipt inside, and sealed, is stored in a safe or locked cabinet in the Property Department or elsewhere.

When it is time to return the suitcase to the owner, the PVS912 Bag is accessed with the receipt thereon used to confirm the transfer of the sealed PVS912 Bag. The PVS912 bag is opened to retrieve the Reclaim Receipt, which is presented to the Property Department. The person claiming the sealed bag 12 signs the Reclaim Receipt that stays with the Property Dept as proof that the sealed bag 12 was returned as described.

The tamper-evident system and methods provide a tamper-evident functionality since in order to access the bag 12 contents an unauthorized individual would need to cut or tear the bag 12 open, leaving an obvious gash or the visible (taped over) hole. Otherwise, one cannot get access to the contents of the bag 12 through the opening, since breaking the security seal 210 (which is permanently closed) will indicate tampering. Further, if the unauthorized individual opens the seal 210 with the plan to use another security tie 210 to close the bag, there will be an obvious mismatch between the tag number 332 and the 4-part form 300 still on and in the bag 12, because each tag 210 is uniquely numbered. If the person were to use a new 4-part form 300 and a new security tie 210, there will be an obvious numerical mismatch to the Reclaim Receipt that is locked away in tamper-evident PVS912 bag that is in a secure spot.

If a person were to open the bag 12 and then reload the old bag (or a new bag) to try to recreate the appearance of non-tampering, the original number has been recorded into the patient's file in a log book or a computer to control the return of the original Reclaim Receipt. There will be a mismatch of the numbers between the new and the old parts and forms.

A person could attempt to copy all of the parts of the present invention so that he had a matching set to the parts in use. That would mean purchasing (with lead times) a large number of numbered security ties 210, printing a large number of pre-printed and numbered 4-part NCR forms 300, and making a large number of PVS912 AYS Reclaim Receipt bags. This person would have to have access to the secured PVS912 Bag to match that switch out as well.

Alternative embodiments to the present invention include other situations where bulk kit items or a small collection of items need to be kept securely. All of the items are needed for a kit to operate properly.

As an example of the present invention, a fire department needs to keep track of contaminated turn out gear that needs to be cleaned or laundered. A kit to solve the fire department's laundering challenges includes a set of multiple tamper-evident bags and a receipt—all with the same unique numeric or alpha numeric ID—each of the following items:
a series of 4 padlock style security ties all with the same number, 1 padlock attached to each piece of turn out gear (only 2 padlocks needed for 2-piece gear sets)
a bag with holes punched as described to hold one person's contaminated turn out gear
a security tie to secure the bag holding the contaminated gear
a second bag with holes punched as described that the laundry uses to hold one person's cleaned gear
a second security tie to secure the bag holding the cleaned gear
a receipt for the sending fire fighter

The contaminated gear arrives at the laundry, is separated, cleaned, dried, and then matched up to the numbers on the padlock style ties. The 4 (or 2) parts are then loaded into a new bag, secured, and returned to the sending department.

Another situation in which a kit embodiment could be used includes fire department trucks that carry Pediatric Medical Bags (“Pedi Bags”) that have multiple zippered pockets to hold highly specialized items for emergency medical care of children. In theory, each and every zipper is opened and the pocket contents checked at every shift change (every 24 hours). In reality this does not happen as planned. At best, a person looks to see that each zipper is closed and possible secured with a small plastic tie that might be numbered. But there is no independent record of the correct small tie numbers.

Traditionally the collection of evidence for law enforcement purposes involves placing items into the flat file type of tamper-evident plastic bags and sealing them. However, items that are bulky and/or too large for these evidence bags are often placed in cardboard cartons or even in plastic trash bags, and sometimes sealed with so called tamper-evident tape which can easily be lifted and replaced without detection. For example, a forensic specialist or other law enforcement agent carrying a computer that is not taped, or placed in a carton that is taped, to be used as evidence in an investigation. It appears that the reason for this evidence being unprotected or unsecured is that the computer is too bulky to fit into an evidence bag and possibly there were no cartons suitable or available to hold it. The present invention can alleviate this problem by enclosing the computer or other evidence using the present invention to indicate if the evidence has been tampered with.

In another embodiment, there are holes in the upper corners of a three-dimensional open top paper bag made manufacturing process. A serial numbered security tie would be threaded through the holes and closed. The number of the security tie would be recorded in an evidence log and on paperwork that is inside and outside the bag. This embodiment would be useful when a paper bag is needed. For example, police departments keep articles of clothing as evidence of a rape case in a gusseted three-dimensional paper bag, because the plastic bag has properties that are not conductive to be proper storage of certain biological items. The bag closure can range from staples to tape and even to so-called tamper-evident tape all of which can be removed from the bag and be replaced without being detected. The present invention provides evidence of tampering while greatly improving the integrity of the evidence from collection time to professional evaluation and testing.

Another embodiment could be used for law enforcement or a coroner is for human remains. Normally, human remains are recovered in a body bag, sometimes with a tag attached to the body listing when and where recovered, perhaps with a name. A zipper closes the body bag, which might be capable of taking a simple zipper lock; however, the container is not tamper-evident.

An embodiment of this invention includes a security tie that can be placed around the ankle or wrist, for example, the remains placed into a bag made according to the present invention. The bag is securely closed by a numbered security tie. If there is physical property of the decedent it can be loaded into another one of the property bags and secured with another security tie. All the security ties have exactly the same number or slight variations of the same number to indicate “on body”, “outer bag” or “property bag”. The number is also on a separate sheet and included in a log or written report. The security ties could be upgraded to use the RFID technology to make it easier to locate specific bags with less labor and confusion.

Another embodiment includes a sausage-shaped bag made from tubular, sausage-shaped plastic in which one or both ends are open. Each of these open ends can be securely closed by threading a plastic security tie through the holes placed on the lip side of each of the openings.

Further, a cardboard box is made “in the flat” from two-dimensional materials by cutting, bending, folding and gluing to create a carton. After loading: the contents into the carton, a carton is kept closed with various types of adhesive tapes or glues. To make the carton closing method tamper-evident in accordance with the present invention, there are standard tamper-evident tapes that can be used to seal the carton closed. However, these cartons can be opened and their contents accessed before being placed into a new carton that appears exactly the same as the original including the standard tamper-evident tape.

The present invention would incorporate punched holes on either side of the final two outer flaps that close the carton, on the top and on the bottom of the carton. The tamper-evident system and method utilizes one set of holes per set of flaps, or two sets of holes, or even more sets of holes depending upon the size of the carton. In accordance with the present invention, a numbered security tie is looped through one hole and the hole opposite it and closed. This can be repeated for each set of holes in the carton. The security ties numbers are recorded in relation to the identity of the carton as described herein and independent connection to the number can come from digital pictures, log files, multi-part forms, etc.

Further, there is no need to punch multiple holes into a carton to create a secure tamper-evident closure. Instead, the carton can be placed into a clear plastic bag with the necessary holes and using the numbered security tie or ties and independent data element form (logs, photos, forms, etc.) as described herein.

As such, a tamper-evident system and method can be implemented utilizing a two or three-dimensional tamper-evident container or bag, in various capacity sizes, and the related components, as described herein, which will serve to deter and detect tampering with the contents of the container and provide evidence of tampering when it occurs, thus greatly improving the chance of determining the individual tampering with the contents and increasing the integrity of the evidence from collection time to professional evaluation and testing.

The foregoing detailed description of the invention is intended to be illustrative and not intended to limit the scope of the tamper-evident system and methods of the present invention. Changes and modifications are possible with respect to the foregoing description, and it is understood that the invention may be practiced otherwise than that specifically described herein and still be within the scope of the claims.

What is claimed is:

1. A system having tamper-evident qualities for enclosing and securing property held or transferred by others, comprising:
a container, said container being sized and configured to accept and secure a property item, said container having a set of holes, said set of holes comprised of at least one pair of holes, wherein each pair of holes is located at approximately the same height as the other on said container;
a secure closure element, said secure closure element comprising a slot and a tail such that said tail can be inserted into said slot, wherein once said tail is inserted into one pair of holes and inserted into said slot, it cannot be removed without indicating damage to the secure closure element, said secure closure element further comprised of an identification symbol; and
a multiple-part form containing at least two parts of the form, each part including said identification symbol matching said identification symbol on said secure closure element, such that each of said at least two parts of said multiple part form can be associated with said secure closure element, thereby establishing a connection between said container, said secure closure element and said multiple-part form.

2. The tamper-evident system of claim 1, wherein said container is sized and configured to secure a property item having sharp corners such that said sharp corners cannot tear the bag.

3. The tamper-evident system of claim 1, wherein said multiple part form is a log sheet.

4. The tamper-evident system of claim 1, further comprising a photograph of the container with the secure closure element inserted into a pair of holes and said tail inserted into said slot of said secure closure element.

5. The tamper-evident system of claim 1, wherein said container is sized and configured to hold static sensitive items, biological specimens, or bio-hazardous substances.

6. The tamper-evident system of claim 1, wherein said container includes three sets of holes at various heights along the bag.

7. The tamper-evident system of claim 1, wherein said secure closure element includes a head portion having a locking hole, a tail portion having jagged edges and a pointed tip, such that the pointed tip can be inserted into the locking hole and cannot be retracted from the locking hole after insertion.

8. The tamper-evident system of claim 1, wherein said multiple part form indicates various information such as identification of the owner of the property items and information about the specific contents inside the three-dimensional bag.

9. The tamper-evident system of claim 1, additionally comprised of a container having a pouch, said pouch being configured such that one part of the multiple part form could be securely stored in said pouch.

10. The tamper-evident system of claim 1, additionally comprised of a container having a pouch such that a second bag with corresponding security information could be stored in the pouch for use after the first bag is used.

11. A method of creating a tamper-evident enclosure apparatus, comprising the steps of:
obtaining a bag having one open aperture, where the bag is sized and configured to confine property items;
punching one or more holes in the bag;
threading a security tie through the one or more holes in the bag;
fixing a security identification tag to the security tie;
fastening the security tie so as to close the open aperture;
recording the security identification details on a multiple part form;
giving a part of said multiple part form with the owner of the property items;
keeping a part of said multiple part form inside of said bag; and
storing a part of said multiple part form with the non-owning entity.

12. A bag system comprised of a bag, a secure closure element, and disturbance detection system, said bag including secure closure element receiving aperture, said disturbance detection system having multiple parts; said secure closure element fastening a part of the disturbance detection system to the bag.
